(19) United States
(12) Patent Application Publication
(10) Pub. No.: US 2026/0057316 A1
(43) Pub. Date: Feb. 26, 2026

(54) AID MANAGEMENT SERVER

(71) Applicant: NTT DOCOMO, INC., Tokyo (JP)

(72) Inventors: Yuta TOYAMA, Chiyoda-ku (JP); Masaki NAKAMURA, Chiyoda-ku (JP); Kazuhiko TAKENO, Chiyoda-ku (JP)

(73) Assignee: NTT DOCOMO, INC., Tokyo (JP)

(21) Appl. No.: 18/855,745

(22) PCT Filed: Mar. 22, 2023
(86) PCT No.: PCT/JP2023/011252

§ 371 Date: Oct. 10, 2024

(30) Foreign Application Priority Data
May 11, 2022 (JP) 2022-078038

(51) Int. Cl. G06Q 10/0631; B60L 53/68; B60L 55/00

(52) U.S. Cl. CPC G06Q 10/06311; B60L 53/68; B60L 55/00

(57) ABSTRACT

An aid management server that can continuously aid a facility using an aid vehicle is provided. In an EMS server 100, an aid facility information receiving unit 102 and an EV data receiving unit 103 acquire EV data including location information and a battery capacity of an EV 200 which is a mobile vehicle and location information and a battery capacity of a facility 300 to be aided. An aid target facility determining unit 104 determines the facility 300 to be aided on the basis of a location of the EV 200. For the determined facility 300 to be aided, a power supply aid schedule determining unit 105 performs control such that the EV 200 is caused to aid the facility 300 to be aided on the basis of the location information and energy information such as the battery capacity.

### DESCRIPTION

### Technical Field

The present invention relates to an aid management server that manages aid of a facility using a vehicle.

### Background Art

In general, electric vehicles (EVs) are often simply considered as automobiles, but recently EVs have come to be expected to be used for anti-disaster measures by considering the EVs as distributed power supplies in anti-disaster measures.

A main use method is a method of causing an EV to serve as a backup of electric power by causing the EV to run to a facility and supplying electric power to the facility from a battery (a storage battery) of the EV when a disaster or the like breaks out and a blackout occurs in the facility. In the related art, a battery (a storage battery) is used as an emergency power supply when electric power cutoff occurs.

In Patent Literature 1, it is described that an electric vehicle (EV) secures a discharging capacity required for a load device, a dischargeable capacity which can be discharged from a backup battery is calculated, and the backup battery is caused to discharge electric power according to the dischargeable capacity when there is an external power supply request.

### CITATION LIST

### Patent Literature

[Patent Literature 1] Japanese Unexamined Patent Publication No. 2020-96416

### SUMMARY OF INVENTION

### Technical Problem

When electric power cutoff occurs in a facility to be aided and a blackout is predicted to occur, power supply aid is performed by causing an EV to run to the facility. Here, in actual disasters, for how long aid should be provided is not often clear.

Therefore, in order to solve the aforementioned problem, an objective of the present invention is to provide an aid management server that can continuously aid a facility using an aid vehicle.

### Solution to Problem

An aid management server according to the present invention is an aid management server that manages a mobile vehicle and a facility to be aided, the aid management server including: an acquisition unit configured to acquire location information and energy information on stored energy of the mobile vehicle and location information and energy information on stored energy of the facility to be aided; and a control unit configured to perform control such that the mobile vehicle is caused to aid the facility to be aided on the basis of the location information and the energy information.

### Advantageous Effects of Invention

According to the present invention, it is possible to continuously aid a facility to be aided.

### BRIEF DESCRIPTION OF DRAWINGS

FIG. 1 is a diagram illustrating a system configuration of an element management system (EMS) server 100 which is an aid management server according to a first embodiment of the present disclosure.

FIG. 2 is a block diagram illustrating a functional configuration of the EMS server 100.

FIG. 3 is a flowchart illustrating operations of the EMS server 100.

FIG. 4 is a flowchart illustrating a detailed process of S106.

FIG. 5 is a diagram schematically illustrating an aid schedule according to the first embodiment.

FIG. 6 is a flowchart illustrating operations of an EMS server 100 according to a second embodiment.

FIG. 7 is a diagram schematically illustrating an aid schedule according to the second embodiment.

FIG. 8 is a diagram illustrating an example of a hardware configuration of an EMS server 100 according to one embodiment of the present disclosure.

### DESCRIPTION OF EMBODIMENTS

Hereinafter, embodiments of the present invention will be described with reference to the accompanying drawings. As much as possible, the same elements will be referred to by the same reference signs and repeated description thereof will be omitted.

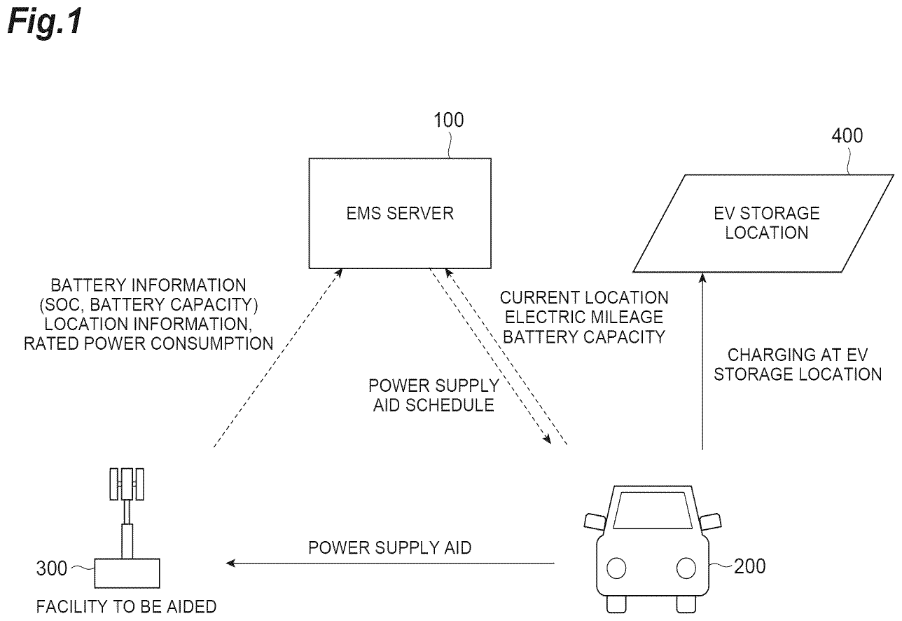

A first embodiment of the present disclosure will be first described below. FIG. 1 is a diagram illustrating a system configuration of an element management system (EMS) server 100 which is an aid management server according to a first embodiment of the present disclosure. As illustrated in the drawing, the EMS server 100 acquires a current location (an EV storage location 400), an electric mileage, and a battery capacity form an EV 200. The EMS server 100 acquires battery information (such as a state of charge (SOC) and a battery capacity) and location information of a plurality of facilities 300 to be aided (which include facilities 300a and 300b to be aided) from the plurality of facilities 300 to be aided. The EMS server 100 performs aid control of the facilities 300 to be aided on the EV 200 using the acquired information. That is, the EMS server 100 transmits an aid schedule indicating the facilities 300 to be aided and amounts of electric power to be supplied to a driver of the EV 200 as an example of the aid control. In another specific example, the EMS server 100 may transmit navigation data of the aid schedule to the EV 200, and a driver of the EV 200 may drive while seeing the navigation data and perform an aid operation.

The EV 200 is stored in the EV storage location 400, and a driver drives the EV 200 and moves to a facility 300 to be aided from the EV storage location 400 in response to notification of the aid schedule from the EMS server 100. A charging facility is provided in the EV storage location 400, and the EV 200 has been subjected to a charging process in advance and is in a fully charged state before movement for aid.

When an aid schedule is received from the EMS server 100, the driver of the EV 200 performs an aid operation on the facility 300 to be aided according to the aid schedule. After the aid operation has ended, the EV 200 moves to the EV storage location 400 through the driver's driving and is subjected to a charging process. The driver can supply electric power of the EV 200 without exhausting the electric power of the facility 300 to be aided until the power supply of the facility 300 to be aided is restored by repeating aid and charging.

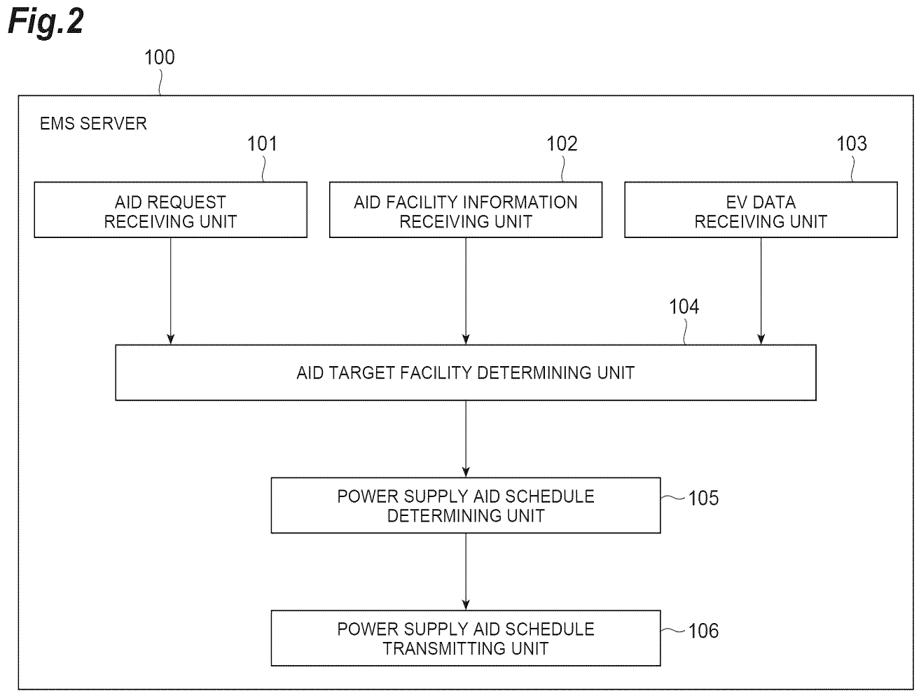

A functional configuration of the EMS server 100 will be described below. FIG. 2 is a block diagram illustrating the functional configuration of the EMS server 100. As illustrated in the drawing, the EMS server 100 includes an aid request receiving unit 101, an aid facility information receiving unit 102, an EV data receiving unit 103, an aid target facility determining unit 104, a power supply aid schedule determining unit 105, and a power supply aid schedule transmitting unit 106.

The aid request receiving unit 101 is a part that receives aid request information from a facility 300 to be aided.

The aid facility information receiving unit 102 is a part that receives aid facility information after receiving the aid request information from the facility 300 to be aided. The aid facility information includes location information of the facility 300 to be aided, battery information of a storage battery provided in the facility 300 to be aided, and rated power consumption of the facility 300 to be aided. The battery information is information including an SOC and a battery capacity of the storage battery.

The EV data receiving unit 103 is a part that receives EV data from an EV 200. The EV data includes a current location (location information of a storage location (the EV storage location 400) of the EV 200 in general), an electric mileage, and a battery capacity of the EV 200.

The aid target facility determining unit 104 is a part that determines a facility 300 to be aided on the basis of the aid request information, the aid facility information, and the EV data. In the present disclosure, it is assumed that a plurality of facilities to be aided (which includes the facility 300 to be aided) transmit an aid request and aid facility information to one EMS server 100 almost at the same time (or in a range with a predetermined time difference) when electric power is cut off at the time of occurrence of a disaster. The aid target facility determining unit 104 determines whether to add a facility to be actually aided to the facilities 300 to be aided sequentially from the facility to be aided closest to the EV storage location 400.

The determination method uses two conditions, where it is determined whether a determination condition (i) in which the storage battery of the EV 200 has not been exhausted while performing EV aid is satisfied and whether a determination condition (ii) in which a storage battery of a facility 300 to be aided has not been exhausted in an execution cycle of EV power supply aid is satisfied. In the determination condition (i), it is determined whether the residual battery capacity is equal to or less than 0 when an amount of electric power SOCi consumed in movement of the EV 200 and an amount of electric power for supply of electric power (aid) are subtracted from a full capacity of the storage battery of the EV 200.

In the determination condition (ii), it is determined that electric power of the storage battery of the facility 300 to be aided is not exhausted at a timing immediately before the facility 300 to be aided is supplied with electric power from the EV 200.

Furthermore, it is assumed that to what % the state of charge (SOC) of the storage battery of each facility 300 to be aided is to be increased such that as many facilities 300 to be aided as possible can be supplied with electric power using one EV 200 is determined by an F-value (an initial value F %: for example, a value close to 80%), and the F-value is decreased to satisfy the determination conditions when a facility 300 to be aided is added to satisfy the determination condition (i) and the determination condition (ii).

For example, when there are three facilities to be aided and only two thereof are used as the facilities 300 to be aided, it is assumed that each facility 300 to be aided is supplied with electric power at 80% while satisfying the determination condition (i) and the determination condition (ii). However, when a third facility 300 to be aided is added, the determination condition (ii) is not satisfied when the state of charge (SOC) of the storage battery of the facility 300 to be aided becomes 0% before the storage battery of the third facility 300 to be aided is supplied with electric power. Accordingly, the aid target facility determining unit 104 determines the facility 300 to be aided while satisfying the determination condition (ii) by decreasing the F-value to 70%.

When the determination condition (ii) is not satisfied in spite of a decrease to 90%, a process of additionally decreasing the F-value by 10% is performed and the determination is performed again. When the determination condition is not satisfied in spite of a decrease by a predetermined % or more, the facility 300 to be aided may be determined not to be aided. The same is true of the determination condition (i).

The power supply aid schedule determining unit 105 is a part that determines a power supply aid schedule for the facilities 300 to be aided. The power supply aid schedule includes the determined facilities 300 to be aided, the aid order thereof (which is normally the ascending order of distances, but is not limited thereto), an amount of supplied electric power indicating to what % charging is to be performed (which corresponds to the F-value which will be described later), and whether the EV 200 is returned to the EV storage location 400 and is charged.

The power supply aid schedule transmitting unit 106 is a part that transmits the power supply aid schedule to a terminal carried by the driver of the EV 200.

When the power supply aid schedule is received, the driver fully charges the EV 200 in the EV storage location 400 (or the EV is in the fully charged state already), moves to the first facility 300 to be aided, and performs charging of the facility 300 to be aided from the EV 200 until the state of charge (SOC) becomes the F-value (for example, the initial value 80%). Thereafter, the driver returns to the EV storage location 400 and fully charges the EV 200. The driver moves to the second facility 300 to be aided, charges the facility 300 to be aided to the F-value, returns to the EV storage location 400, and fully charges the EV 200. The driver moves to the third facility 300 to be aided, charges the facility 300 to be aided to the F-value, returns to the EV storage location 400, and fully charges the EV 200.

Thereafter, the driver repeats the loop of power supply aid on the first facility 300 to be aided.

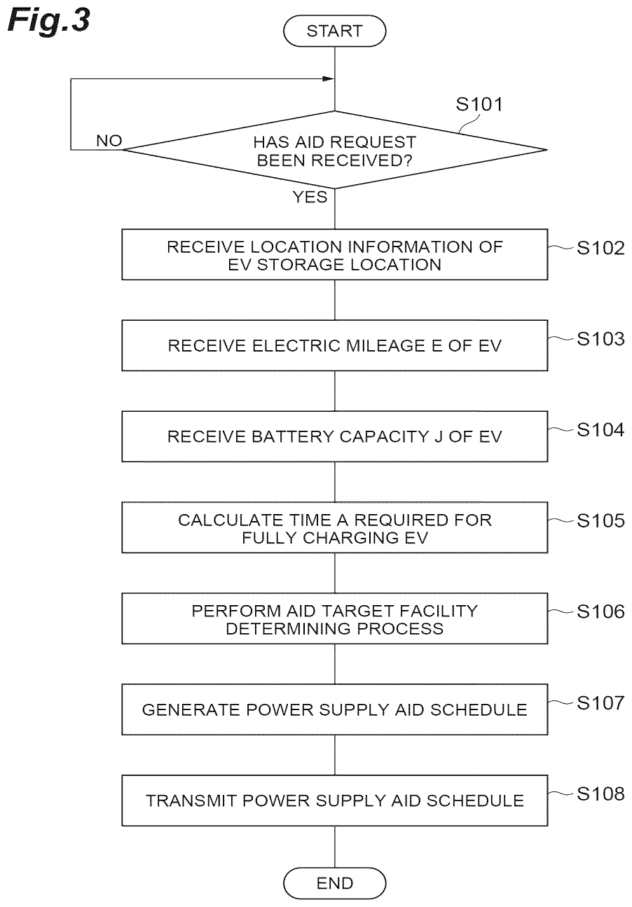

Operations of the EMS server 100 according to the present disclosure will be described below. FIG. 3 is a flowchart illustrating operations of the EMS server 100.

The aid request receiving unit 101 and the aid facility information receiving unit 102 receive an aid request and aid facility information (such as location information and battery information) transmitted from each facility 300 to be aided with occurrence of a disaster (S101).

The EV data receiving unit 103 receives location information of the EV storage location 400, an electric mileage E of the EV 200, and a battery capacity J of the EV 200 and calculates a time A required for fully charging the EV 200 (S102 to S105). The electric mileage E represents a distance per 1 kW. The full charging time A is defined as a time from 0 to a fully charged state. In the present disclosure, a residual capacity of the battery of the EV 200 at the time of charging changes depending on an aid situation in the facility 300 to be aided, and it is assumed that the charging time from 0 is calculated with a margin. Accordingly, the full charging time A is substantially a default value.

The aid target facility determining unit 104 determines an aid target sequentially from the closest facility 300 to be aided out of a plurality of facilities 300 to be aided having transmitted an aid request on the basis of the location information of the aid facility information of the facilities 300 to be aided and the location information of the EV 200. Then, one or more facilities 300 to be aided are determined on the basis of the state of charge of the storage battery of the facility 300 to be aided and the state of charge of the EV 200 (S106).

The power supply aid schedule determining unit 105 generates a power supply aid schedule including the facilities 300 to be aided determined as an aid target by the aid target facility determining unit 104, the aid order thereof, and an amount of supplied electric power (the F-value) (S107).

The power supply aid schedule transmitting unit 106 transmits the power supply aid schedule (S108).

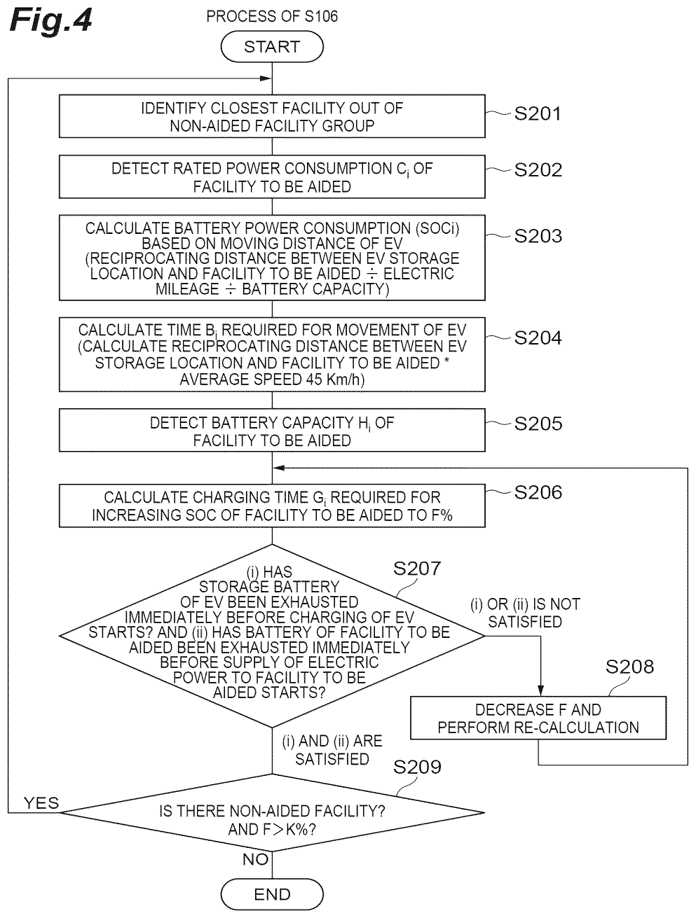

A detailed process of S106 will be described below. FIG. 4 is a flowchart illustrating the detailed process of S106. In this flow, i denotes a facility 300 to be aided.

The aid target facility determining unit 104 identifies one closest facility 300 to be aided out of a group of aid facilities having transmitted an aid request on the basis of the location information in the aid facility information and the location information of the EV 200 (S201).

The power supply aid schedule determining unit 105 detects a rated power consumption Ci of the identified facility 300 to be aided from the aid facility information received in S101 (S202).

The power supply aid schedule determining unit 105 calculates battery power consumption (SOCi) of the battery of the EV 200 according to a moving distance of the EV 200 to the facility 300 to be aided (S203). Specifically, the aid target facility determining unit 104 calculates a “reciprocating distance between the EV storage location 400 and the identified facility 300 to be aided”÷an electric mileage÷a battery capacity and calculates the battery power consumption (SOCi) of the EV 200 used for the facility 300 to be aided. Regarding the moving distance, a moving route between the EV storage location 400 and the facility 300 to be aided and a moving distance (a reciprocating distance) thereof are calculated on the basis of known route retrieval.

The power supply aid schedule determining unit 105 calculates a time Bi required for movement of the EV 200 (S204). For example, the power supply aid schedule determining unit 105 calculates the “reciprocating distance between the EV storage location 400 and the identified facility 300 to be aided”*an average speed 45 km/h and calculates the time Bi. The average speed 45 km/h is a default value and is a numeral which can be appropriately changed.

The power supply aid schedule determining unit 105 detects a battery capacity Hi of the facility 300 to be aided (S205).

Then, the power supply aid schedule determining unit 105 calculates a charging time Gi required for increasing the SOC indicating the state of charge of the facility 300 to be aided to the F-value (unit: %) (S206).

The power supply aid schedule determining unit 105 determines (i) whether the storage battery of the EV 200 is exhausted at a timing immediately before charging of the EV 200 starts and (ii) whether the storage battery of the facility 300 to be aided has been exhausted at a timing immediately before supply of electric power to the facility 300 to be aided starts (S207). When both the determination condition (i) and the determination condition (ii) are satisfied, the facility 300 to be aided identified in S201 is set as an aid target.

Specifically, the power supply aid schedule determining unit 105 calculates the battery capacity J of the EV 200*(100%−SOCi)≥Hi*F % and determines the determination condition (i). The power supply aid schedule determining unit 105 calculates Hi×F %≥the “full charging time A of the EV 200+the moving time Bi+the charging time Gi of the facility to be aided”*the “power consumption Ci of the facility 300 to be aided” and determines the determination condition (ii).

Here, when the determination condition (i) or the determination condition (ii) is not satisfied (S207: (i) or (ii) is not satisfied), the power supply aid schedule determining unit 105 decreases the F-value and performs the process gain (S208). For example, the F-value is updated by F-value=F-value−10 (decrease by 10%), and the process is performed again. The present disclosure is not limited to the determinations, and the following process may be performed. That is, when the determination condition (ii) is not satisfied, the determination condition (ii) is not often satisfied in spite of a further decrease of the F-value. Accordingly, the facility 300 to be aided may be excluded from the aid target. In this case, for example, the facility 300 to be aided may include a storage battery with a capacity much greater than the capacity of the storage battery of the EV 200.

Then, when both the determination condition (i) and the determination condition (ii) are satisfied in S207, the power supply aid schedule determining unit 105 additionally determines whether there is a non-aided facility and whether F>K is satisfied (S209). Here, K is a threshold value, and charging is not sufficient when the storage battery of less than K % in the facility 300 to be aided is charged. Accordingly, in the present disclosure, even when there is a non-aided facility, it is assumed that an aid process is not performed thereon any more. Here, when the F-value is updated in S208, the updated value is used.

In this way, in the process illustrated in FIG. 4, the facility 300 to be aided in which the determination condition (i) and the determination condition (ii) are satisfied is added as an aid target to the power supply aid schedule. As long as there is a non-aided facility and the F-value is not less than K, the facility 300 to be aided and the facility 300a to be aided are sequentially added to the power supply aid schedule. The determination condition (ii) is a condition in which second aid of the same facility 300 to be aided is considered. That is, in the second aid, whether the state of charge in the first aid is effective (whether the storage battery of the facility 300 to be aided has an effective state of charge) is checked.

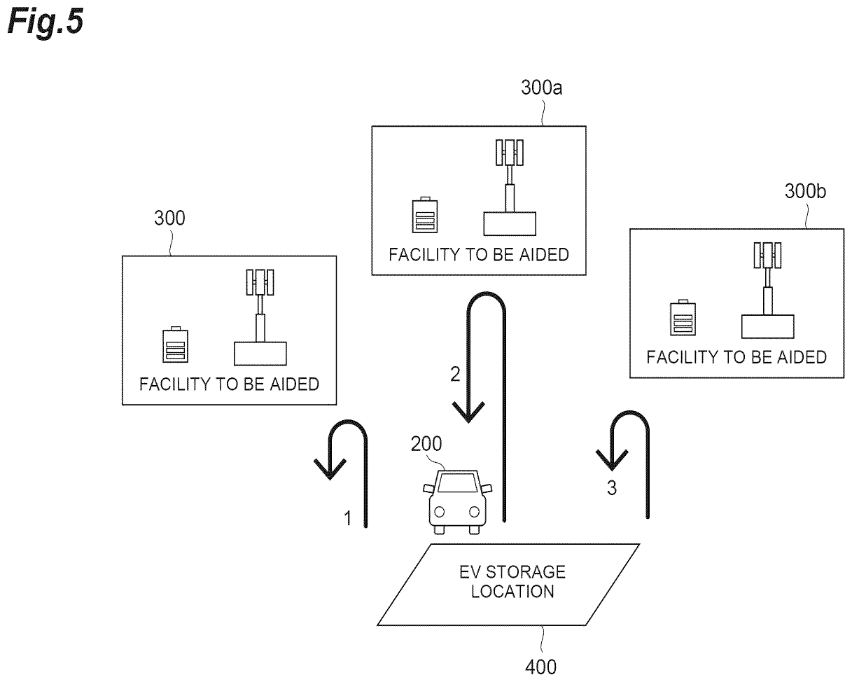

FIG. 5 is a diagram schematically illustrating an aid schedule according to the first embodiment. As illustrated in the drawing, the EV 200 repeats supply of electric power (aid) to the facility 300 to be aided and charging while reciprocating between the EV storage location 400 and the facilities 300, 300a, and 300b to be aided.

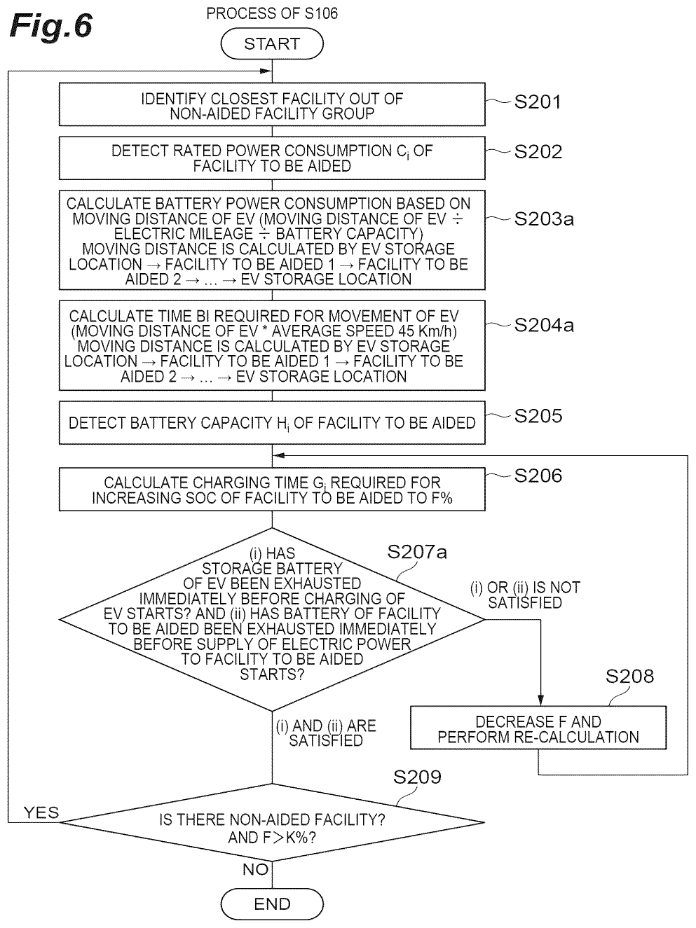

A second embodiment of the present disclosure will be described below. FIG. 6 is a flowchart illustrating operations of an EMS server 100 according to the second embodiment. As illustrated in the drawing, the operations illustrated in FIG. 6 are different from the operations illustrated in FIG. 4 in S203a and S204a.

In the present disclosure, similarly to FIG. 4, the power supply aid schedule determining unit 105 identifies a closest facility 300 to be aided on the basis of location information and acquires facility information of the facility 300 to be aided. At this time, the battery power consumption (SOCi), the time Bi, and the like are acquired according to the moving distance of the EV 200.

That is, in the EMS server 100, the power supply aid schedule determining unit 105 calculates the battery power consumption (SOCi) according to the moving distance of the EV 200 (S203a). As described above, the battery power consumption (SOCi) is calculated by the moving distance of the EV 200÷electric mileage÷battery capacity. The moving distance is calculated from the moving route of the EV storage location 400 of the EV 200→facility to be aided 1→facility to be aided 2→ . . . →the EV storage location 400. Then, the power supply aid schedule determining unit 105 calculates the battery power consumption to each facility 300 to be aided.

For example, the power supply aid schedule determining unit 105 calculates a distance from the EV storage location 400 to the facility to be aided 1 for the battery power consumption (SOC1) of the facility to be aided 1 (I=1) and calculates a distance to the facility to be aided 2 for the battery power consumption (SOC2) of the facility to be aided 2 (I=2). That is, for the facility to be aided 2, the moving distance of the EV storage location 400→the facility to be aided 1→the facility to be aided 2 is calculated.

The power supply aid schedule determining unit 105 calculates a time Bi required for the moving distance of the EV 200 (S204a). As described above, the time Bi is calculated by the moving distance of the EV 200*the average speed 45 km/h. The moving distance is calculated on the basis of a moving route indicated by EV storage location→facility to be aided 1→facility to be aided 2→ . . . →EV storage location.

Then, the power supply aid schedule determining unit 105 calculates the cumulative moving distance and the cumulative time Bi whenever a facility 300 to be aided is added.

The power supply aid schedule determining unit 105 determines whether the determination condition (i) and the determination condition (ii) in each facility to be aided are satisfied in S207a. When both the determination condition (i) and the determination condition (ii) are satisfied, the facility 300 to be aided is added as an aid target to the power supply aid schedule.

When there is a facility to be aided and F>K is established, the power supply aid schedule determining unit 105 identifies a second closest facility 300 to be aided and repeatedly performs S201 to S209.

The processes including S203a and S204a are based on extraction of one facility 300 to be aided and cumulative values thereof. For example, the power supply aid schedule determining unit 105 identifies a facility to be aided 1 as a first facility and determines whether the determination condition (i) and the determination condition (ii) are satisfied therein. Here, a moving distance based on a moving route of the EV storage location 400→the facility to be aided 1→the EV storage location 400 is calculated, and the battery power consumption is calculated according to the calculated moving distance (S203a). The power supply aid schedule determining unit 105 calculates the time Bi according to the moving distance of the EV 200 for the facility to be aided 1 (S204a).

Then, when it is determined using the battery power consumption and the time Bi that the determination condition (i) and the determination condition (ii) are satisfied and there is a non-aided facility (S209: YES), a next facility to be aided 2 is identified, and cumulative values of the battery power consumption and the time Bi are calculated according to the moving distance of the EV 200. Here, the moving distance is calculated on the basis of a moving route of the EV storage location 400→the facility to be aided 1→the facility to be aided 2→the EV storage location 400.

Thereafter, when there is a facility to be aided 3, various types of information are acquired on the basis of a moving distance in consideration of the facility to be aided 3.

Through this process, a process of aiding a facility 300 to be aided can be continuously performed without returning to the EV storage location 400 of the EV 200 after the aid process.

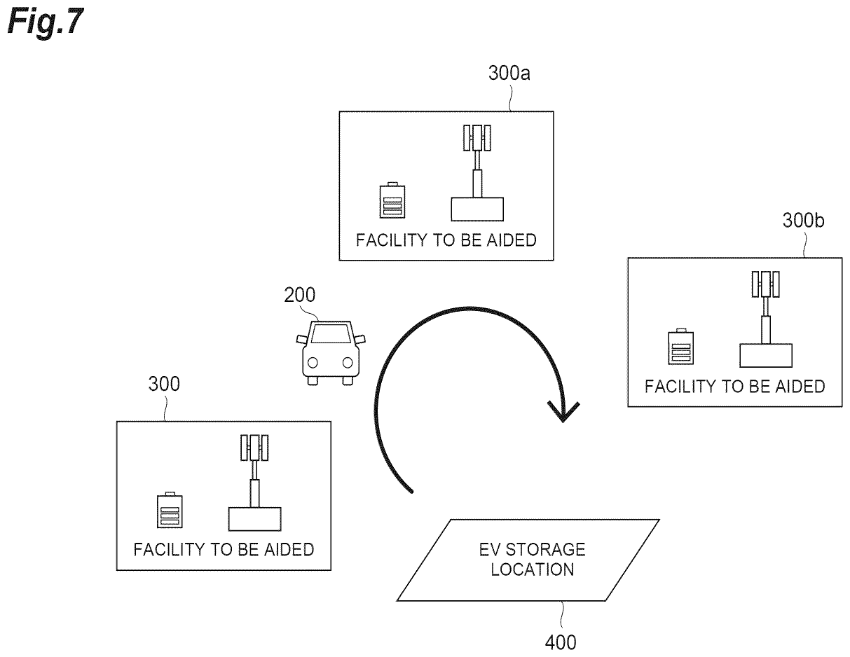

FIG. 7 is a diagram schematically illustrating an aid schedule according to the second embodiment. As illustrated in the drawing, the EV 200 moves to the facility 300 to be aided to the facility 300b to be aided for the successive aid process without returning to the EV storage location 400.

Operations and advantages of the EMS server 100 according to the present disclosure (the first embodiment and the second embodiment) will be described below. In the EMS server 100 according to the present disclosure, the aid facility information receiving unit 102 and the EV data receiving unit 103 acquire EV data including location information and a battery capacity of an EV 200 which is a mobile vehicle (energy information on energy stored therein) and location information and a battery capacity of a facility 300 to be aided (energy information on energy stored therein). Then, the aid target facility determining unit 104 determines a facility 300 to be aided on the basis of the location of EV 200. For the determined facility 300 to be aided, the power supply aid schedule determining unit 105 performs control such that the EV 200 aids the facility 300 to be aided on the basis of the location information and the energy information such as the battery capacity. In the present disclosure, control is to generate an aid schedule and may include another.

In the present disclosure, power supply aid is performed by supplying electric power to a storage battery of a facility 300 to be aided using a battery of an EV 200, but the present disclosure is not limited to an EV 200. A battery may be mounted in a regular automobile and aid may be performed using the battery.

The present disclosure is not limited to supply of electric power using a battery of an EV 200, and aid may be performed by supplying general energy. A supply object includes fuel such as gasoline and gas. In this case, a vehicle moving with the fuel as a power source can be preferably used instead of the EV 200.

The aid target facility determining unit 104 identifies a facility to be aided on the basis of location information of an EV 200 and location information of a facility 300 to be aided.

The power supply aid schedule determining unit 105 determines whether the determination condition (i) (a first condition) indicating that SOCi (an amount of energy) of a storage battery after an EV 200 which is a mobile vehicle has moved includes an amount of electric power (an amount of energy) supplied to the identified facility 300 to be aided is satisfied. That is, in this case, the power supply aid schedule determining unit 105 serves as a vehicle energy determining unit and determines whether the storage battery of the EV 200 has been exhausted immediately before the EV 200 starts charging in the EV storage location 400. This is determination for preventing the EV 200 from not returning to the EV storage location 400 due to energy exhaustion (battery exhaustion) or not completing aid. The EV storage location 400 serves as an energy supply location.

The power supply aid schedule determining unit 105 determines whether the determination condition (ii) (a second condition) indicating that an amount of electric power (energy) stored in the facility 300 to be aided does not enter a predetermined state is satisfied when the EV 200 performs aid of an amount of electric power (an amount of energy) of the facility 300 to be aided. That is, the power supply aid schedule determining unit 105 serves as a facility energy determining unit and determines whether the storage battery of the facility 300 to be aided is exhausted immediately before the EV 200 starts supply of electric power to the facility 300 to be aided. Since the EV 200 moves to another facility 300 to be aided or the EV storage location 400, it takes time to arrive at the facility 300 to be aided and to start supply of electric power. Accordingly, at the time of start of supply of electric power, the facility 300 to be aided needs to be a facility 300 to be aided of which the storage battery is not exhausted.

The power supply aid schedule determining unit 105 generates an aid schedule for the facility 300 to be aided on the basis of the determination result. That is, the power supply aid schedule determining unit 105 serves as a control unit and performs control such that the EV 200 aids the facility 300 to be aided by generating an aid schedule of the EV 200 on the basis of the determination condition (i) (the first condition) and the determination condition (ii) (the second condition).

With this configuration, when energy of electrical energy of the EV 200 is supplied to a facility 300 to be aided, it is possible to enable continuously supplying of energy. Accordingly, the facility 300 to be aided continues to operate until energy is restored.

When one of the determination condition (i) and the determination condition (ii) (the first condition and the second condition) is not satisfied, the power supply aid schedule determining unit 105 corrects an amount of electric power (an amount of energy) supplied to the facility 300 to be aided and determines whether the determination condition (i) and the determination condition (ii) are satisfied again. That is, when the storage battery of the facility 300 to be aided is charged in F %, it is tried to satisfy the determination conditions by reducing the F-value.

Accordingly, it is possible to select facilities 300 to be aided which can be successively aided.

The power supply aid schedule determining unit 105 determines whether the determination condition (ii) is satisfied on the basis of an aid time in the facility 300 to be aided using the EV 200 and an amount of residual energy (Hi*F %) in the facility 300 to be aided. Here, the aid time includes a full charging time A of the EV 200, a moving time Bi of the EV 200, and a time Gi (an energy supply time) required for charging to F %. Only one type of information may be used. The full charging time A is a time in consideration of a battery capacity consumed in charging of the facility 300 to be aided to F % of the battery capacity Hi and movement of the EV and may be substantially a time from a state in which the residual battery capacity of the EV 200 is 0 to a fully charged state. Similarly, the time Gi is a time based on a residual capacity of the storage battery in consideration of the power consumption Ci of the facility 300 to be aided and may be substantially a time from a state in which the residual capacity of the storage battery is 0 to a state in which the storage battery is charged in F %.

With this configuration, it is determined whether the storage battery of the facility 300 to be aided is not exhausted at a timing immediately before supply of electric power to the facility 300 to be aided starts in consideration of the aid time using the EV 200.

Accordingly, it is possible to determine accurate conditions and to select facilities 300 to be aided which can be successively aided.

The power supply aid schedule determining unit 105 determines whether the determination condition (ii) is satisfied by comparing the state of charge (Hi*F %) of the storage battery of the facility 300 to be aided with an amount of energy consumed (time*consumed electric power Ci) in the facility 300 to be aided based on the aid time.

In the present disclosure, the aid facility information receiving unit 102 and the EV data receiving unit 103 acquire location information of an EV 200 and location information of a facility 300 to be aided and serve as a location information acquiring unit. The power supply aid schedule determining unit 105 calculates a moving time of the EV 200 which is an aid time on the basis of the location information.

Accordingly, it is possible to accurately ascertain the aid time of the EV 200.

The power supply aid schedule determining unit 105 determines whether the determination condition (i) is satisfied in consideration of an amount of energy consumed in movement of the EV 200. That is, the EV 200 operates with a battery (a storage battery) and performs a process of aiding a facility 300 to be aided using the battery. Accordingly, it is possible to ascertain how the EV 200 can supply electric power to the facility 300 to be aided in consideration of consumption of electricity which is energy stored in the battery.

An aid management server which is the EMS server 100 according to the present disclosure employs the following configuration.

[1]

An aid management server that manages a mobile vehicle and a facility to be aided, the aid management server comprising:
an acquisition unit configured to acquire location information and energy information on stored energy of the mobile vehicle and location information and energy information on stored energy of the facility to be aided; and
a control unit configured to perform control such that the mobile vehicle is caused to aid the facility to be aided on the basis of the location information and the energy information.
   [2]

The aid management server according to [1], further comprising:
a vehicle energy determining unit configured to determine whether a first condition indicating that a post-movement amount of energy of the mobile vehicle includes an amount of energy to be supplied to the facility to be aided is satisfied on the basis of the energy information; and
a facility energy determining unit configured to determine whether a second condition indicating that an amount of energy stored in the facility to be aided does not reach a predetermined state is satisfied when the mobile vehicle starts supply of energy to the facility to be aided on the basis of the energy information,
wherein the control unit performs control such that the mobile vehicle is caused to aid the facility to be aided on the basis of the first condition and the second condition.
   [3]

The aid management server according to [2], wherein the post-movement amount of energy is calculated on the basis of a round-trip distance the vehicle travels between an energy supply location of the mobile vehicle and the facility to be aided.

[4]

The aid management server according to [2], wherein, when there are a plurality of facilities to be aided, the post-movement amount of energy is calculated on the basis of a distance over which the mobile vehicle returns from an energy supply location of the mobile vehicle to the energy supply location via the plurality of facilities to be aided.

[5]

The aid management server according to any one of [2] to [4], wherein the control unit corrects the amount of energy to be supplied when one of the first condition and the second condition is not satisfied, and
wherein the vehicle energy determining unit and the facility energy determining unit determine whether the first condition and the second condition are satisfied again.
   [6]

The aid management server according to any one of [2] to [5], wherein the facility energy determining unit determines whether the second condition is satisfied on the basis of an aid time in the facility to be aided using the mobile vehicle and the amount of energy stored in the facility to be aided.

[7]

The aid management server according to [6], wherein the aid time includes at least one of a time over which the mobile vehicle is supplied with energy, a time in which the mobile vehicle moves between a supply location and the facility to be aided, and a time in which energy is supplied to the facility to be aided.

[8]

The aid management server according to [6] or [7], wherein the facility energy determining unit determines whether the second condition is satisfied by comparing an amount of energy consumed in the facility to be aided based on the aid time with the amount of stored energy.

[9]

The aid management server according to any one of [2] to [9], wherein the vehicle energy determining unit determines whether the first condition is satisfied in consideration of an amount of energy consumed through movement of the mobile vehicle as the first condition.

[10]

The aid management server according to any one of [1] to [9], wherein the control unit generates an aid schedule of the mobile vehicle for the facility to be aided as the control for performing aid.

The block diagram used for the description of the above embodiments shows blocks of functions. Those functional blocks (component parts) are implemented by any combination of at least one of hardware and software. Further, a means of implementing each functional block is not particularly limited. Specifically, each functional block may be implemented by one physically or logically combined device or may be implemented by two or more physically or logically separated devices that are directly or indirectly connected (e.g., by using wired or wireless connection etc.). The functional blocks may be implemented by combining software with the above-described one device or the above-described plurality of devices.

The functions include determining, deciding, judging, calculating, computing, processing, deriving, investigating, looking up/searching/inquiring, ascertaining, receiving, transmitting, outputting, accessing, resolving, selecting, choosing, establishing, comparing, assuming, expecting, considering, broadcasting, notifying, communicating, forwarding, configuring, reconfiguring, allocating/mapping, assigning and the like, though not limited thereto. For example, the functional block (component part) that implements the function of transmitting is referred to as a transmitting unit or a transmitter. In any case, a means of implementation is not particularly limited as described above.

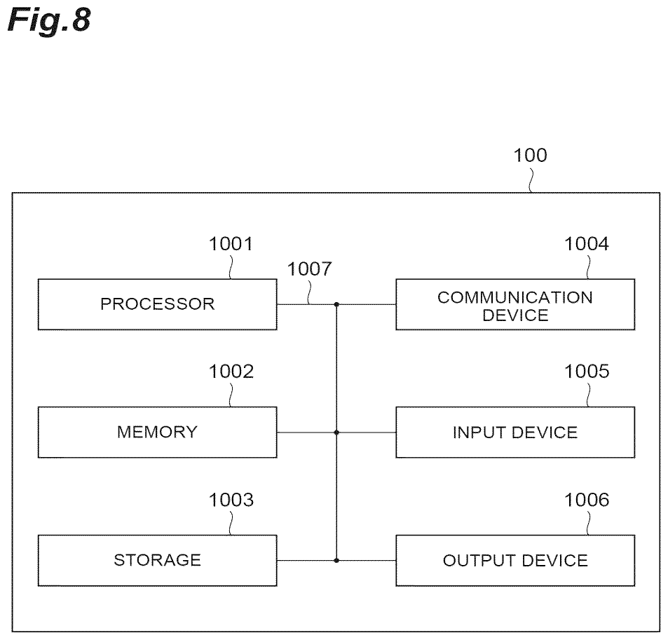

For example, the EMS server 100 according to one embodiment of the present disclosure may function as a computer that performs processing of an aid management according to the present disclosure. FIG. 8 is a view showing an example of the hardware configuration of the EMS server 100 according to one embodiment of the present disclosure. The EMS server 100 described above may be physically configured as a computer device that includes a processor 1001, a memory 1002, a storage 1003, a communication device 1004, an input device 1005, an output device 1006, a bus 1007 and the like.

In the following description, the term “device” may be replaced with a circuit, a device, a unit, or the like. The hardware configuration of the EMS server 100 may be configured to include one or a plurality of the devices shown in the drawings or may be configured without including some of those devices.

The functions of the EMS server 100 may be implemented by loading predetermined software (programs) on hardware such as the processor 1001 and the memory 1002, so that the processor 1001 performs computations to control communications by the communication device 1004 and control at least one of reading and writing of data in the memory 1002 and the storage 1003.

The processor 1001 may, for example, operate an operating system to control the entire computer. The processor 1001 may be configured to include a CPU (Central Processing Unit) including an interface with a peripheral device, a control device, an arithmetic device, a register and the like. For example, the aid target facility determining unit 104, the power supply aid schedule determining unit 105 and the like described above may be implemented by the processor 1001.

Further, the processor 1001 loads a program (program code), a software module and data from at least one of the storage 1003 and the communication device 1004 into the memory 1002 and performs various processing according to them. As the program, a program that causes a computer to execute at least some of the operations described in the above embodiments is used. For example, the aid target facility determining unit 104 and the power supply aid schedule determining unit 105 may be implemented by a control program that is stored in the memory 1002 and operates on the processor 1001, and the other functional blocks may be implemented in the same way. Although the above-described processing is executed by one processor 1001 in the above description, the processing may be executed simultaneously or sequentially by two or more processors 1001. The processor 1001 may be implemented in one or more chips. Note that the program may be transmitted from a network through a telecommunications line.

The memory 1002 is a computer-readable recording medium, and it may be composed of at least one of ROM (Read Only Memory), EPROM (ErasableProgrammable ROM), EEPROM (Electrically ErasableProgrammable ROM), RAM (Random Access Memory) and the like, for example. The memory 1002 may be also called a register, a cache, a main memory (main storage device) or the like. The memory 1002 can store a program (program code), a software module and the like that can be executed for implementing an aid management method according to one embodiment of the present disclosure.

The storage 1003 is a computer-readable recording medium, and it may be composed of at least one of an optical disk such as a CD-ROM (Compact Disk ROM), a hard disk drive, a flexible disk, a magneto-optical disk (e.g., a compact disk, a digital versatile disk, and a Blu-ray (registered trademark) disk), a smart card, a flash memory (e.g., a card, a stick, and a key drive), a floppy (registered trademark) disk, a magnetic strip and the like, for example. The storage 1003 may be called an auxiliary storage device. The above-described storage medium may be a database, a server, or another appropriate medium including at least one of the memory 1002 and/or the storage 1003, for example.

The communication device 1004 is hardware (a transmitting and receiving device) for performing communication between computers via at least one of a wired network and a wireless network, and it may also be referred to as a network device, a network controller, a network card, a communication module, or the like. The communication device 1004 may include a high-frequency switch, a duplexer, a filter, a frequency synthesizer or the like in order to implement at least one of FDD (Frequency Division Duplex) and TDD (Time Division Duplex), for example. For example, the above-described aid request receiving unit 101, aid facility information receiving unit 102, and EV data receiving unit 103 or the like may be implemented by the communication device 1004. The communication device 1004 may be implemented in such a way that a transmitting unit and a receiving unit are physically or logically separated.

The input device 1005 is an input device (e.g., a keyboard, a mouse, a microphone, a switch, a button, a sensor, etc.) that receives an input from the outside. The output device 1006 is an output device (e.g., a display, a speaker, an LED lamp, etc.) that makes output to the outside. Note that the input device 1005 and the output device 1006 may be integrated (e.g., a touch panel).

In addition, the devices such as the processor 1001 and the memory 1002 are connected by the bus 1007 for communicating information. The bus 1007 may be a single bus or may be composed of different buses between different devices.

Further, the EMS server 100 may include hardware such as a microprocessor, a DSP (Digital Signal Processor), an ASIC (Application Specific Integrated Circuit), a PLD (Programmable Logic Device), and an FPGA (Field Programmable Gate Array), and some or all of the functional blocks may be implemented by the above-described hardware components. For example, the processor 1001 may be implemented with at least one of these hardware components.

Notification of information may be made by another method, not limited to the aspects/embodiments described in the present disclosure. For example, notification of information may be made by physical layer signaling (e.g., DCI (Downlink Control Information), UCI (Uplink Control Information)), upper layer signaling (e.g., RRC (Radio Resource Control) signaling, MAC (Medium Access Control) signaling, annunciation information (MIB (Master Information Block), SIB (System Information Block))), another signal, or a combination of them. Further, RRC signaling may be called an RRC message, and it may be an RRC Connection Setup message, an RRC Connection Reconfiguration message or the like, for example.

The procedure, the sequence, the flowchart and the like in each of the aspects/embodiments described in the present disclosure may be in a different order unless inconsistency arises. For example, for the method described in the present disclosure, elements of various steps are described in an exemplified order, and it is not limited to the specific order described above.

Input/output information or the like may be stored in a specific location (e.g., memory) or managed in a management table. Further, input/output information or the like can be overwritten or updated, or additional data can be written. Output information or the like may be deleted. Input information or the like may be transmitted to another device.

The determination may be made by a value represented by one bit (0 or 1), by a truth-value (Boolean: true or false), or by numerical comparison (e.g., comparison with a specified value).

Each of the aspects/embodiments described in the present disclosure may be used alone, may be used in combination, or may be used by being switched according to the execution. Further, a notification of specified information (e.g., a notification of “being X”) is not limited to be made explicitly, and it may be made implicitly (e.g., a notification of the specified information is not made).

Although the present disclosure is described in detail above, it is apparent to those skilled in the art that the present disclosure is not restricted to the embodiments described in this disclosure. The present disclosure can be implemented as a modified and changed form without deviating from the spirit and scope of the present disclosure defined by the appended claims. Accordingly, the description of the present disclosure is given merely by way of illustration and does not have any restrictive meaning to the present disclosure.

Software may be called any of software, firmware, middleware, microcode, hardware description language or another name, and it should be interpreted widely so as to mean an instruction, an instruction set, a code, a code segment, a program code, a program, a sub-program, a software module, an application, a software application, a software package, a routine, a sub-routine, an object, an executable file, a thread of execution, a procedure, a function and the like.

Further, software, instructions and the like may be transmitted and received via a transmission medium. For example, when software is transmitted from a website, a server or another remote source using at least one of wired technology (a coaxial cable, an optical fiber cable, a twisted pair and a digital subscriber line (DSL) etc.) and wireless technology (infrared rays, microwave etc.), at least one of those wired technology and wireless technology are included in the definition of the transmission medium.

The information, signals and the like described in the present disclosure may be represented by any of various different technologies. For example, data, an instruction, a command, information, a signal, a bit, a symbol, a chip and the like that can be referred to in the above description may be represented by a voltage, a current, an electromagnetic wave, a magnetic field or a magnetic particle, an optical field or a photon, or an arbitrary combination of them.

Note that the term described in the present disclosure and the term needed to understand the present disclosure may be replaced by a term having the same or similar meaning. For example, at least one of a channel and a symbol may be a signal (signaling). Further, a signal may be a message. Furthermore, a component carrier (CC) may be called a cell, a frequency carrier, or the like.

Further, information, parameters and the like described in the present disclosure may be represented by an absolute value, a relative value to a specified value, or corresponding different information. For example, radio resources may be indicated by an index.

The names used for the above-described parameters are not definitive in any way. Further, mathematical expressions and the like using those parameters are different from those explicitly disclosed in the present disclosure in some cases. Because various channels (e.g., PUCCH, PDCCH etc.) and information elements (e.g., TPC etc.) can be identified by every appropriate names, various names assigned to such various channels and information elements are not definitive in any way.

In the present disclosure, the terms such as “Mobile Station (MS)” “user terminal”, “User Equipment (UE)” and “terminal” can be used to be compatible with each other.

The mobile station can be also called, by those skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or several other appropriate terms.

Note that the term “determining” and “determining” used in the present disclosure includes a variety of operations. For example, “determining” and “determining” can include regarding the act of judging, calculating, computing, processing, deriving, investigating, looking up/searching/inquiring (e.g., looking up in a table, a database or another data structure), ascertaining or the like as being “determined” and “determined”. Further, “determining” and “determining” can include regarding the act of receiving (e.g., receiving information), transmitting (e.g., transmitting information), inputting, outputting, accessing (e.g., accessing data in a memory) or the like as being “determined” and “determined”. Further, “determining” and “determining” can include regarding the act of resolving, selecting, choosing, establishing, comparing or the like as being “determined” and “determined”. In other words, “determining” and “determining” can include regarding a certain operation as being “determined” and “determined”. Further, “determining (determining)” may be replaced with “assuming”, “expecting”, “considering” and the like.

The term “connected”, “coupled” or every transformation of this term means every direct or indirect connection or coupling between two or more elements, and it includes the case where there are one or more intermediate elements between two elements that are “connected” or “coupled” to each other. The coupling or connection between elements may be physical, logical, or a combination of them. For example, “connect” may be replaced with “access”. When used in the present disclosure, it is considered that two elements are “connected” or “coupled” to each other by using at least one of one or more electric wires, cables, and printed electric connections and, as several non-definitive and non-comprehensive examples, by using electromagnetic energy such as electromagnetic energy having a wavelength of a radio frequency region, a microwave region and an optical (both visible and invisible) region.

The description “on the basis of” used in the present disclosure does not mean “only on the basis of” unless otherwise noted. In other words, the description “on the basis of” means both of “only on the basis of” and “at least on the basis of”.

When the terms such as “first” and “second” are used in the present disclosure, any reference to the element does not limit the amount or order of the elements in general. Those terms can be used in the present disclosure as a convenient way to distinguish between two or more elements. Thus, reference to the first and second elements does not mean that only two elements can be adopted or the first element needs to precede the second element in a certain form.

As long as “include”, “including” and transformation of them are used in the present disclosure, those terms are intended to be comprehensive like the term “comprising”. Further, the term “or” used in the present disclosure is intended not to be exclusive OR.

In the present disclosure, when articles, such as “a”, “an”, and “the” in English, for example, are added by translation, the present disclosure may include that nouns following such articles are plural.

In the present disclosure, the term “A and B are different” may mean that “A and B are different from each other”. Note that this term may mean that “A and B are different from C”. The terms such as “separated” and “coupled” may be also interpreted in the same manner.

### REFERENCE SIGNS LIST

100 . . . EMS server, 101 . . . Aid request receiving unit, 102 . . . Aid facility information receiving unit, 103 . . . EV data receiving unit, 104 . . . Aid target facility determining unit, 105 . . . Power supply aid schedule determining unit, 106 . . . Power supply aid schedule transmitting unit, 300 . . . Facility to be aided, 300a . . . Facility to be aided, 300b . . . Facility to be aided, 400 . . . EV storage location

1. An aid management server that manages a mobile vehicle and a facility to be aided, the aid management server comprising:
an acquisition unit configured to acquire location information and energy information on stored energy of the mobile vehicle and location information and energy information on stored energy of the facility to be aided; and
a control unit configured to perform control such that the mobile vehicle is caused to aid the facility to be aided on the basis of the location information and the energy information.

2. The aid management server according to claim 1, further comprising:
a vehicle energy determining unit configured to determine whether a first condition indicating that a post-movement amount of energy of the mobile vehicle includes an amount of energy to be supplied to the facility to be aided is satisfied on the basis of the energy information; and
a facility energy determining unit configured to determine whether a second condition indicating that an amount of energy stored in the facility to be aided does not reach a predetermined state is satisfied on the basis of the energy information when the mobile vehicle starts supply of energy to the facility to be aided,
wherein the control unit performs control such that the mobile vehicle is caused to aid the facility to be aided on the basis of the first condition and the second condition.

3. The aid management server according to claim 2, wherein the post-movement amount of energy is calculated on the basis of a round-trip distance the vehicle travels between an energy supply location of the mobile vehicle and the facility to be aided.

4. The aid management server according to claim 2, wherein, when there are a plurality of facilities to be aided, the post-movement amount of energy is calculated on the basis of a distance over which the mobile vehicle returns from an energy supply location of the mobile vehicle to the energy supply location via the plurality of facilities to be aided.

5. The aid management server according to claim 2, wherein the control unit corrects the amount of energy to be supplied when one of the first condition and the second condition is not satisfied, and
wherein the vehicle energy determining unit and the facility energy determining unit determine whether the first condition and the second condition are satisfied again.

6. The aid management server according to claim 2, wherein the facility energy determining unit determines whether the second condition is satisfied on the basis of an aid time in the facility to be aided using the mobile vehicle and the amount of energy stored in the facility to be aided.

7. The aid management server according to claim 6, wherein the aid time includes at least one of a time over which the mobile vehicle is supplied with energy, a time in which the mobile vehicle moves between a supply location and the facility to be aided, and a time in which energy is supplied to the facility to be aided.

8. The aid management server according to claim 6, wherein the facility energy determining unit determines whether the second condition is satisfied by comparing an amount of energy consumed in the facility to be aided based on the aid time with the amount of stored energy.

9. The aid management server according to claim 2, wherein the vehicle energy determining unit determines whether the first condition is satisfied in consideration of an amount of energy consumed through movement of the mobile vehicle as the first condition.

10. The aid management server according to claim 1, wherein the control unit generates an aid schedule of the mobile vehicle for the facility to be aided as the control for performing aid.
